(19) United States
(12) Patent Application Publication
(10) Pub. No.: US 2009/0293302 A1
(43) Pub. Date: Dec. 3, 2009

(54) ARTWORK DRYING CABINET AND METHOD

(76) Inventors: Helbert J. Jonaitis, Jacksonville, FL (US); Steven Wallis, Jacksonville, FL (US)

Correspondence Address: MARK YOUNG, P.A., 12086 FORT CAROLINE ROAD, UNIT 202, JACKSONVILLE, FL, 32225, US

(21) Appl. No.: 12/473,271

(22) Filed: May 27, 2009

Related U.S. Application Data
(60) Provisional application No. 61/056,581, filed on May 28, 2008.

(51) Int. Cl. F26B 3/02; F26B 25/06; F26B 25/18; F26B 21/06

(52) U.S. Cl. 34/467; 34/202; 34/235; 34/218; 34/239; 34/72

(57) ABSTRACT

An artwork drying cabinet includes a housing that defines an interior drying compartment. A plurality of removable shelves are provided in parallel spaced relation within the compartment. A hinged door provides access to the compartment for purposes of loading and removing shelves with artwork. The door includes a vent to exhaust moisture laden air from the compartment. A blower and heating element are provided to supply a heated current of air to the compartment. A shroud couples the blower and heating element to the cabinet and directs the flow of heated air into the cabinet. The blower sends the current of air over the heating element through a diffuser comprising a v-shaped baffle with a central elongated opening along the vertex. Controls are provided to regulate air speed and temperature. An optional timer controls the duration of a drying cycle. The diffuser evenly distributes parallel laminar streams of heated air above and below each shelf. The shelves feature relatively large openings that allow streams of heated air to simultaneously contact the top and the bottom of the artwork supported on the shelf. The dual sided contact maintains an even pressure distribution and facilitates drying.

### RELATED APPLICATION

This application is a Nonprovisional of and claims the benefit of priority of U.S. Provisional Application 61/056,581 filed 28 May 2008, the entire contents of which are incorporated herein by this reference and made a part hereof.

### FIELD OF THE INVENTION

This invention relates generally to drying artwork, and, more particularly, to a system and method for efficiently accelerating the drying of a plurality of wet artwork pieces.

### BACKGROUND

Artisans have long used hair dryers to accelerate the drying of paintings and other wet artwork. Such artwork may include a painting, faux painting sample, a finished cabinet or door, or the like. A continuously moving hair dryer aimed at a wet substance will substantially reduce the amount of time required to dry by increasing the rate of evaporation of liquid components. Unfortunately, however, hair dryers have serious shortcomings.

First and foremost, hair dryers are highly inefficient, consuming about 2000 watts or more to rapidly heat a nichrome wire heating element. Several artisans drying their artworks, each using a hair dryer in the same room, may easily overload a circuit and trip a circuit breaker. Tripped circuit breakers and blown fuses are frequent occurrences in art classes. Additionally, because much of the heated air is deflected from the surface of the artwork, the temperature of the room is increased. In a small room with several artists using hair dryers, the temperature can quickly increase to an uncomfortable level.

Furthermore, anyone who has dried their hair with a blow dryer will attest to annoying noise levels. The noise in a room with several hair dryers activated at the same time is deafening, drowning out all other sounds, including telephones and speech.

Moreover, hair dryers tend to damage artwork. The emitted narrow, powerful jet of hot air will deform (e.g., ripple or otherwise misshape) wet artwork if positioned too close to the artwork. Even if a hair dryer is positioned a safe distance to avoid physical deformation, unless it is continuously moved, the heat transfer will steadily increase the temperature of the targeted artwork until an unsafe temperature is reached, causing damage. Such damage may include warping, discoloration, and cracking.

A device that evenly accelerates drying of several artwork pieces simultaneously, without excessive heating, noise or impact on the surface of the artwork, is needed. The invention is directed to overcoming one or more of the problems and solving one or more of the needs as set forth above.

### SUMMARY OF THE INVENTION

To solve one or more of the problems set forth above, in an exemplary implementation of the invention, an artwork drying cabinet is provided. The cabinet comprises a housing that defines an interior drying compartment. A plurality of removable shelves are provided in parallel spaced relation within the compartment. A hinged door provides access to the compartment for purposes of loading and removing shelves with artwork. The door includes a vent to exhaust moisture laden air from the compartment.

A blower and heating element are provided to supply a heated current of air to the compartment. A shroud couples the blower and heating element to the cabinet and directs the flow of heated air into the cabinet. The blower sends the current of air over the heating element through a diffuser comprising a v-shaped baffle with a central elongated opening along the vertex. Controls are provided to regulate air speed and temperature. An optional timer controls the duration of a drying cycle.

The diffuser evenly distributes parallel laminar streams of heated air above and below each shelf. The shelves comprise removable supportive frameworks featuring relatively large openings. Streams of heated air contact the top and, through the openings, the bottom of the artwork supported on the shelf. The dual sided contact maintains an even pressure distribution and facilitates drying.

The cabinet is scalable and modular. The cabinet may be configured to house a wide range of artwork, various dimensions, and a range of shelves. The cabinet and shelves may vary in size to accommodate a wide range of artwork, such as clays, paintings, color swatches, faux painting samples, doors and any other generally planar subject matter that requires air drying. Cabinet sizes may vary from small desktop versions to large standalone modules.

Thus, in one embodiment, an exemplary artwork drying cabinet includes a housing with a plurality of shelf supports. The shelf supports are configured to support a plurality of shelves in horizontal parallel relationship. The housing has a front end and a rear end. A plurality of removable shelves support artwork. A door is mounted to the front end of the housing and configured to provide access into the housing and allow insertion and removal of the plurality of removable shelves. A vent is coupled to the door and configured to facilitate exhaust from the housing. The vent includes a plurality of angled horizontal slats. A shroud has an outlet connected to the rear end of the housing. The shroud defines a channel that fluidly couples the fan to the housing. A fan coupled to the inlet of the shroud forces a current of air through the shroud into the housing. An electrical heating element disposed between the fan and housing heats the current of air from the fan before the current of air enters the housing. A fan control switch controls fan speed. A heating element control switch controls temperature of the heating element. An electrical power supply cord supplies electrical power to the fan and heating element from an outlet. A power switch disposed between the electrical power supply cord and the fan and heating element controls supply of electrical power via the electrical power supply cord. A diffuser is disposed in the shroud between the electrical heating element and the housing. The diffuser is configured to distribute the current of air evenly in the housing. The fan and heating element are contained in a blower and heating element unit.

The diffuser is a symmetrical V-shaped baffle, with first and second panels joined by a filleted vertex, and a central aperture formed in the vertex. Top and bottom flanges are provided to mount the diffuser in the shroud. When installed, the diffuser defines three openings (i.e., passages) through which the current of air passes. A first opening includes the central aperture. A second opening is between the first panel and the housing. A third opening is between the second panel and the housing.

Each shelf includes a frame and at least one longitudinal rib defining openings between the frame and the at least one longitudinal rib. The openings allow heated air to contact the bottom of artwork supported on the shelf. A shelf may include bottom feet configured to provide elevated support. The shelves may be spaced an equal vertical distance apart in the housing. The distance is greater than a height of artwork supported on each of the shelves.

A method of drying artwork using an artwork drying cabinet as described above is also provided. The method entails placing each of a plurality of pieces of artwork to be dried flat on each of the plurality of shelves, one piece of artwork per shelf. Next the door to the housing is opened. Then the shelves are inserted into the housing by sliding them onto the shelf supports. Next the door is closed. Then, a fan speed is selected using the fan control switch. Next a temperature is selected using the temperature control switch. Then the fan and heating element are energized by turning on the power switch. Periodically a determination is made whether drying is complete. When drying is complete, the power switch is turned off, the door is opened and the shelves and artwork pieces are removed. These steps may be repeated for several drying cycles to determine an average drying time for a selected fan speed and selected temperature. Subsequent drying cycles may then be timed to determine when drying is completed.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a top perspective view of an exemplary artwork drying cabinet according to principles of the invention; and

FIG. 2 is a perspective view of an exemplary shelf for an artwork drying cabinet according to principles of the invention; and

FIG. 3 is a perspective view of an exemplary artwork piece supported on a shelf for an artwork drying cabinet according to principles of the invention; and

FIG. 4 is a front section view (A-A, FIG. 1) of an exemplary artwork drying cabinet according to principles of the invention; and

FIG. 5 is a side section view (B-B, FIG. 1) of an exemplary artwork drying cabinet according to principles of the invention; and

FIG. 6 is a top perspective view of an exemplary artwork drying cabinet with an open door and partially removed shelf according to principles of the invention; and

FIG. 7 is a rear perspective view of an exemplary artwork drying cabinet according to principles of the invention; and

FIG. 8 is a plan view of an exemplary diffuser for an artwork drying cabinet according to principles of the invention; and

FIG. 9 is a front perspective view of an exemplary diffuser for an artwork drying cabinet according to principles of the invention; and

FIG. 10 is a rear perspective view of an exemplary diffuser for an artwork drying cabinet according to principles of the invention; and

FIG. 11 is a front perspective view of an exemplary shelf for an artwork drying cabinet according to principles of the invention; and

FIG. 12 is a front perspective view of another exemplary shelf with bottom feet for an artwork drying cabinet according to principles of the invention; and

FIG. 12 is a profile view of the exemplary shelf with bottom feet for an artwork drying cabinet according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the types of vent, handle configuration, shelf configuration, shapes, relative sizes, ornamental aspects or proportions shown in the figures.

### DETAILED DESCRIPTION

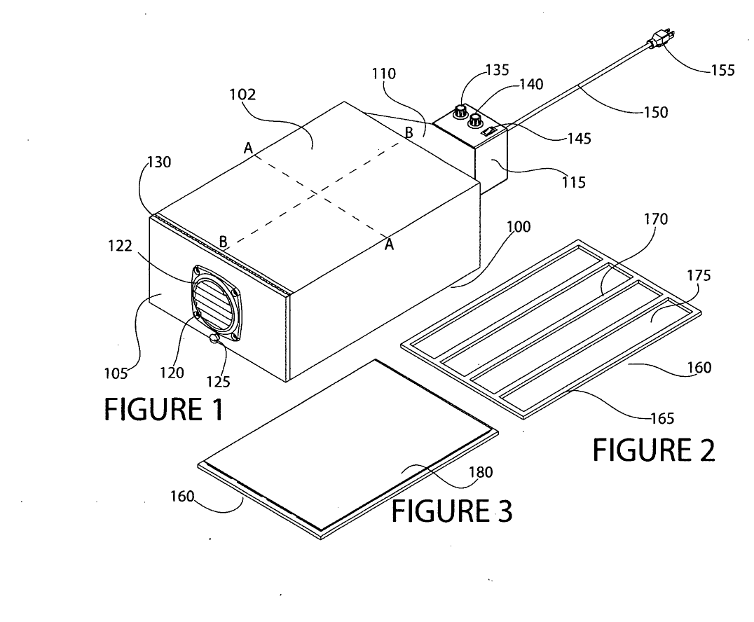

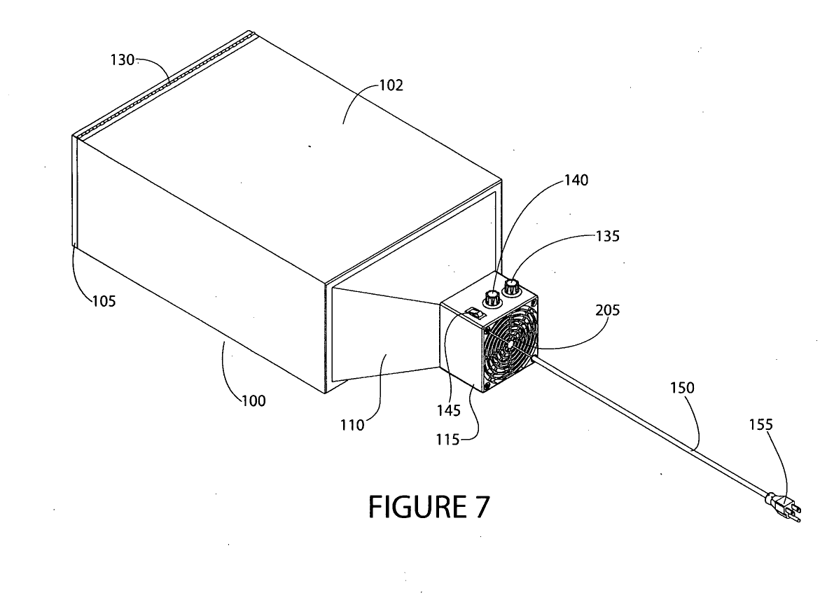

Referring to the Figures, in which like parts are indicated with the same reference numerals, various views of an exemplary artwork drying cabinet and components thereof according to principles of the invention are shown. With particular reference to FIGS. 1, 6 and 7, perspective views of an exemplary artwork drying cabinet 100 according to principles of the invention are shown. The cabinet 100 includes a housing 102 that defines an interior compartment. The exemplary housing 102 comprises parallel top and bottom panels and parallel side panels. As discussed below, the housing 102 contains removable shelves for supporting artwork to be dried. A current of heated air flows over the shelves in the housing 102.

A door 105 is provided to enable access to the interior compartment of the housing. A handle 125 facilitates manually opening and closing the door 105. The exemplary door 105 is mounted with door hardware, such as a hinge 130 attached to the housing 102. Optionally, a lock, latch or magnetic closure may be provided to releasably secure the door in a closed position.

Importantly, heated moisture-laden air is not recirculated. Recirculation is undesirable as the moisture hinders the evaporation process and fouls the blower and heating element. Instead, a vent 120 is provided to exhaust heated moisture-laden air blown through the compartment. By way of example and not limitation, the vent 120 may be positioned over an aperture in the door 105. The exemplary vent 120 includes a plurality of horizontal slats that are angled to keep out debris while allowing exhaust air to escape. Optionally, the vent may include an annular collar 122 that can be connected to one end of an exhaust hose. In such an embodiment, the other end of the exhaust hose may lead to outdoors, a well ventilated area, a filtration system, a chemical exhaust hood or some other desired exhaust location.

A blower and heating element unit 115 is provided to supply a heated current of air to the compartment. The unit 115 contains a blower with an inlet 205 and an outlet 200 that emits a current of heated air into the shroud 100. The blower may comprise an axial-flow fan with blades that force air to move parallel to the shaft about which the blades rotate; a centrifugal fan also called a “squirrel cage” having a central shaft about which a set of blades, or ribs, are positioned and configured to blow air at a right angle to the shaft; a cross flow fan which is a centrifugal fan configured to blow air parallel to the blades; or any other type of high volume air moving mechanism.

The unit 115 also contains a heating element that converts electricity into heat. Electric current through the element encounters resistance, resulting in heating of the element. The heating element may, by way of example and not limitation, employ nickel-chromium, FeCrAl or Copper nickel alloy resistance wire. Air blown through the unit 110 is heated as it passes over the heating element.

The blower and heating element unit 115 includes controls. By way of example, controls are provided to regulate air speed 135 and temperature 140 and to controllably energize the unit 145. An optional timer may be provided to set the duration of a drying cycle. Electricity is supplied via a power cord 150 and plug 155 through an electrical outlet.

A shroud 110 couples the blower and heating element unit 115 to the cabinet and directs the flow of heated air into the cabinet. The shroud comprises a hopper shaped channel that fluidly couples the outlet 200 of the blower and heating element unit 115 to the housing 102, as shown in the section view of FIG. 5.

An exemplary blower and heating element unit 115 operates from standard utility power (e.g., 120V A/C) outputs approximately 2000 to 6000 BtuH per 9 cubic feet of interior compartment space, and at least a 100 cfm flow rate. A commercially available blower and heating element unit that meets these specifications is the Dayton® Electric Convection Heater model 3VU37A available from Dayton Electric Manufacturing Co. of Niles, Ill.

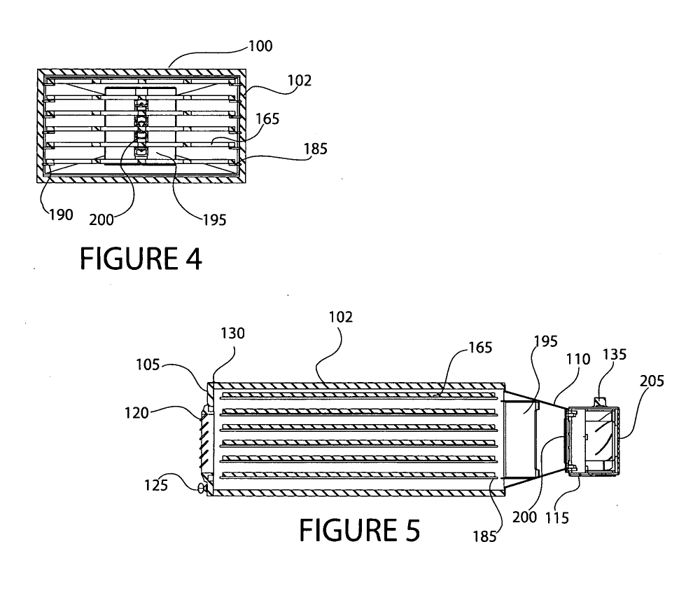

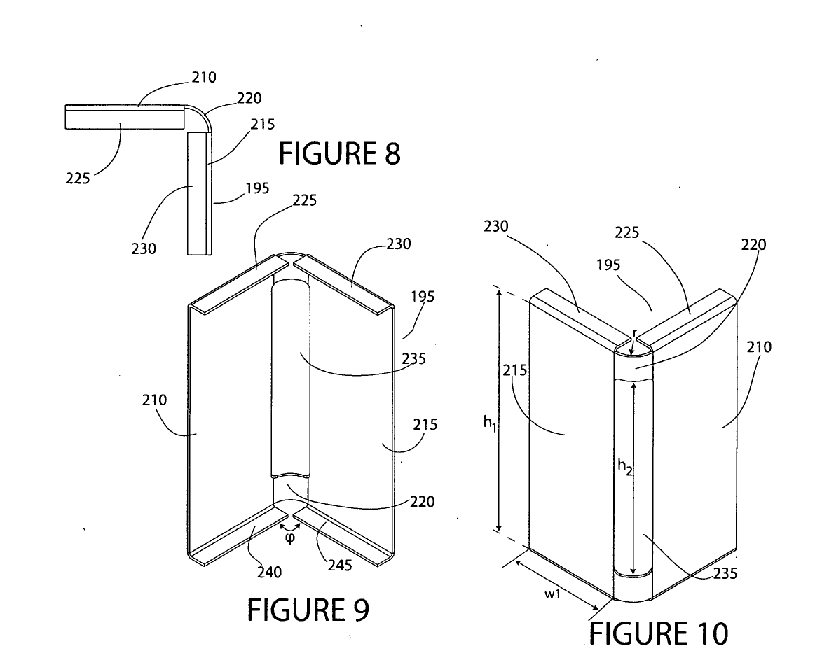

A diffuser 195 is disposed in the shroud to evenly diffuse or spread out the air flow emitted from the blower and heating element unit 115, as shown in FIGS. 4 and 5. With reference to FIGS. 8-10, the diffuser 195 comprises a symmetrical V-shaped baffle with first 210 and second 215 panels joined by a filleted (i.e., rounded) vertex 220. A slot-like central aperture 235 is formed in the vertex 220. Top 225, 230 and bottom 240, 245 flanges are provided to mount the diffuser 195 in the shroud 110.

The dimensions of the diffuser may vary substantially to accommodate a shroud 110 and housing 102 configuration. The height h₁ of the diffuser 195 is less than the height of the shroud 110 and less than the height of the housing 102. The angle (p between the first 210 and second 215 panels may be 90° as illustrated, or obtuse or acute, depending upon the configuration of the shroud 110 and outlet 200. In an exemplary embodiment, the height h₂ of the aperture 235 is between 25% and 95% of h₁; the width w₁ of each panel is approximately at least ½ of the width of the blower outlet 200 divided by the cosine of φ/2. The radius r of the vertex 220 is approximately 1 to 25% the width w₁ of each panel.

Most air emitted through the outlet 200 impacts the diffuser 195, is compressed and flows through one of three main openings. One opening is the central aperture 235. A space also exists between the each panel 210, 215 and the adjacent interior sidewall of the shroud 110. Thus, heated air flows through the aperture 235 and between the first 210 and second 215 panels and the interior side walls of the shroud 110, after which the heated air expands into the compartment of the housing 105. This diffuser 195 configuration provides a substantially even flow (i.e., a flow having the same or substantially similar flow velocity at each shelf level) parallel to the shelves in the compartment. The substantially parallel flow over the shelves exhibits little or no turbulence and does not distort artwork supported on each shelf.

Referring now to FIGS. 2 and 3, artwork 180 is supported by shelves 160. The shelves comprise a frame 165 with longitudinal ribs 170 and openings 175 between the frame and ribs and between adjacent ribs. The openings 175 allow heated air to contact the bottom of the artwork. Simultaneously heating the bottom and the top of the artwork 160 accelerates evaporation.

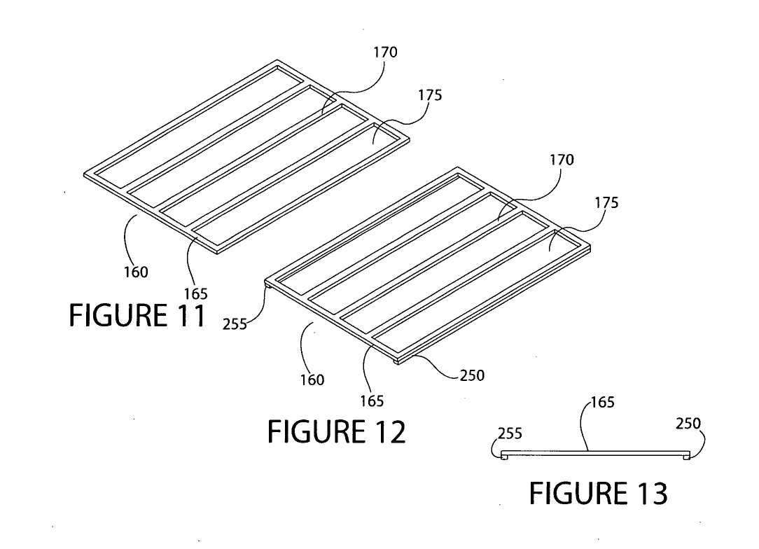

With reference now to FIGS. 4, 5, 6 and 11, a plurality of shelves 160 and supported artwork may be inserted into the housing 102 for a drying cycle. The shelves are supported in spaced apart parallel relation, with the distance between adjacent shelves being approximately equal and greater than the height of the supported artwork. Side supports 185, 190, which are removably or permanently mounted to and projecting from the interior sidewalls of the housing 102, support the shelves. The side supports, which are vertically spaced apart, define the shelf heights. Shelves 160 may be slid into the housing on the supports 185, 190.

A shelf 160 with bottom feet 250, 255, as shown in FIGS. 12 and 13, may be supported on the bottom surface of the housing. The feet 250, 255 allow air to flow beneath the shelf and artwork to facilitate even drying as discussed above.

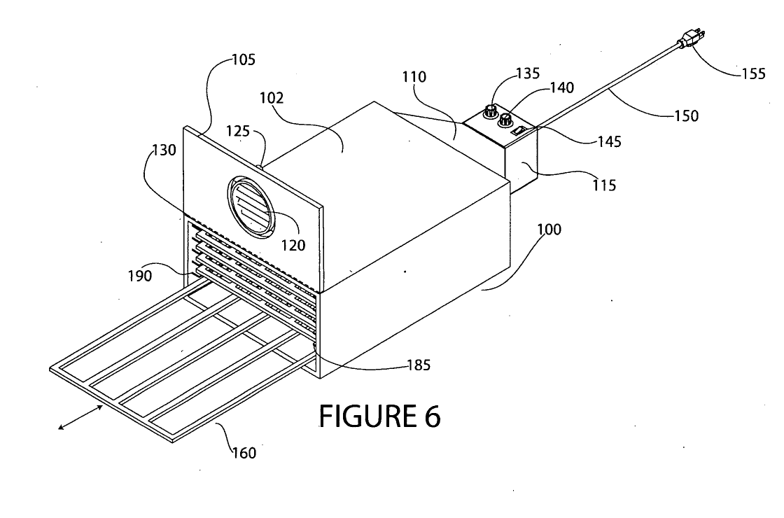

Thus, the housing 102 accommodates a plurality of shelves 160 supporting a plurality of artwork pieces 180. The shelves 160 may be slid into and out of the housing 102 through open door 105, as illustrated in FIG. 6. The shelving configuration ensures even exposure to heated airflow and exposes top and bottom surfaces of the artwork to the airflow.

A method of drying artwork using an artwork drying cabinet according to principles of the invention, includes placing each piece of artwork 180 to be dried flat on a shelf 160. Optionally, clamps may be used to secure the artwork 180 to the shelf. The door 105 to the housing 102 is opened and the shelves 160 are inserted by sliding them onto the shelf supports 185, 190. The door 105 is then closed. The fan speed is then selected using a control 135. The temperature is then also selected using a control 140. The selected fan speed should not disturb (i.e., lift, move or deform) the artwork. The temperature should be safe for exposing the artwork. Temperatures in the range of 90° to 140° F. are preferred. The blower and heating unit 115 is then energized by turning on an switch 145. Air drawn in from the inlet 205 is heated, emitted from the outlet 200, passed by the diffuser 195, through the interior compartment of the housing 102 and out of the exhaust vent 120. Periodically, the artwork 180 may be inspected to determine whether drying is complete. When drying is completed, the on/off switch 145 may be shut off, the door 105 opened, and the shelves 160 and artwork 180 removed. After a few drying cycles have been completed for a particular number of artwork pieces, the average drying time may be determined for a selected fan speed and temperature setting. Subsequent drying cycles may then be timed.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. An artwork drying cabinet comprising:
a housing with a plurality of shelf supports, said shelf supports being configured to support a plurality of shelves in horizontal parallel relationship, and said housing having a front end and a rear end;
a plurality of removable shelves for supporting artwork;
a door mounted to the front end of the housing, said door being configured to provide access into the housing and allow insertion and removal of the plurality of removable shelves;
a vent coupled to the door and configured to facilitate exhaust from the housing;
a shroud having an inlet and an outlet, the outlet of the shroud being connected to the rear end of the housing;
a fan coupled to the inlet of the shroud and configured to force a current of air through the shroud into the housing;
an electrical heating element disposed between the fan and housing, said heating element configured to heat the current of air from the fan before the current of air enters the housing; and
a fan control switch configured to control fan speed;
a heating element control switch configured to control temperature of the heating element;
an electrical power supply cord configured to supply electrical power to the fan and heating element;
a power switch disposed between the electrical power supply cord and the fan and heating element, said power switch controlling supply of electrical power via the electrical power supply cord; and
a diffuser comprising a symmetrical V-shaped baffle disposed in the shroud between the electrical heating element and the housing, said diffuser being configured to distribute the current of air evenly in the housing.

2. An artwork drying cabinet according to claim 1, the housing comprising parallel top and bottom panels.

3. An artwork drying cabinet according to claim 1, the exemplary door hingedly mounted to the front end of the housing.

4. An artwork drying cabinet according to claim 1, the vent comprising a plurality of angled horizontal slats.

5. An artwork drying cabinet according to claim 1, the vent comprising a plurality of angled horizontal slats and an annular collar configured for connection to an end of an exhaust hose.

6. An artwork drying cabinet according to claim 1, the fan comprising an axial-flow fan with blades.

7. An artwork drying cabinet according to claim 1, the fan comprising a centrifugal fan.

8. An artwork drying cabinet according to claim 1, the fan comprising a cross flow fan.

9. An artwork drying cabinet according to claim 1, the shroud comprising a channel that fluidly couples the fan to the housing.

10. An artwork drying cabinet according to claim 1, the fan and heating element being contained in a blower and heating element unit.

11. An artwork drying cabinet according to claim 1, the fan and heating element being contained in a blower and heating element unit and providing approximately 2000 to 6000 BtuH per 9 cubic feet of interior compartment space, and at least a 100 cfm flow rate.

12. An artwork drying cabinet according to claim 1, the diffuser comprising a symmetrical V-shaped baffle, with first and second panels joined by a filleted vertex, and a central aperture formed in the vertex.

13. An artwork drying cabinet according to claim 1, the diffuser comprising a symmetrical V-shaped baffle, with first and second panels joined by a filleted vertex, a central aperture formed in the vertex, and top and bottom flanges configured to mount the diffuser in the shroud.

14. An artwork drying cabinet according to claim 1, the diffuser comprising a symmetrical V-shaped baffle, with first and second panels joined by a filleted vertex, a central aperture formed in the vertex, and top and bottom flanges configured to mount the diffuser in the shroud, said diffuser defining three openings through which the current of air passes, a first opening comprising the central aperture, a second aperture between the first panel and the housing, and a third aperture between the second panel and the housing.

15. An artwork drying cabinet according to claim 1, each shelf comprising a frame and at least one longitudinal rib defining openings between the frame and the at least one longitudinal rib, said openings allowing heated air to contact the bottom of artwork supported on the shelf.

16. An artwork drying cabinet according to claim 1, each shelf comprising a frame and at least one longitudinal rib defining openings between the frame and the at least one longitudinal rib, said openings allowing heated air to contact the bottom of artwork supported on the shelf, and at least one shelf including bottom feet configured to provide elevated support.

17. An artwork drying cabinet according to claim 1, each of the plurality of shelves being spaced an equal vertical distance apart.

18. An artwork drying cabinet according to claim 1, each of the plurality of shelves being spaced an equal vertical distance apart said distance being greater than a height of artwork supported on each of the shelves.

19. A method of drying artwork using an artwork drying cabinet, said artwork drying cabinet comprising:
a housing with a plurality of shelf supports, said shelf supports being configured to support a plurality of shelves in horizontal parallel relationship, and said housing having a front end and a rear end;
a plurality of removable shelves for supporting artwork;
a door mounted to the front end of the housing, said door being configured to provide access into the housing and allow insertion and removal of the plurality of removable shelves;
a vent coupled to the door and configured to facilitate exhaust from the housing;
a shroud having an inlet and an outlet, the outlet of the shroud being connected to the rear end of the housing;
a fan coupled to the inlet of the shroud and configured to force a current of air through the shroud into the housing;
an electrical heating element disposed between the fan and housing, said heating element configured to heat the current of air from the fan before the current of air enters the housing; and
a fan control switch configured to control fan speed;
a heating element control switch configured to control temperature of the heating element;
an electrical power supply cord configured to supply electrical power to the fan and heating element;
a power switch disposed between the electrical power supply cord and the fan and heating element, said power switch controlling supply of electrical power via the electrical power supply cord; and
a diffuser disposed in the shroud between the electrical heating element and the housing, said diffuser being configured to distribute the current of air evenly in the housing; and
said method of drying artwork using the artwork drying cabinet comprising steps of:
placing each of a plurality of pieces of artwork to be dried flat on each of the plurality of shelves, one piece of artwork per shelf,
opening the door to the housing;
inserting each of the shelves into the housing by sliding them onto the shelf supports;
closing the door;
selecting a fan speed using the fan control switch;
selecting a temperature is using the temperature control switch;
energizing the fan and heating element by turning on the power switch;
periodically determining whether drying is complete;
when drying is complete, turning off the power switch, opening the door and removing the shelves and artwork pieces.

20. A method of drying artwork using an artwork drying cabinet according to claim 19, said method further comprising
repeating the steps set forth in claim 19 for a plurality of drying cycles; and determining an average drying time for a selected fan speed and selected temperature; and
timing a subsequent drying cycle to determine when drying is completed.
